(19) United States
(12) Patent Application Publication
(10) Pub. No.: US 2025/0224910 A1
(43) Pub. Date: Jul. 10, 2025

(54) MEDIA DATA GENERATION METHOD AND ELECTRONIC DEVICE

(71) Applicant: Lenovo (Beijing) Limited, Beijing (CN)

(72) Inventors: Ke WANG, Beijing (CN); Yanan CUI, Beijing (CN); Wenlong DU, Beijing (CN)

(21) Appl. No.: 19/006,956

(22) Filed: Dec. 31, 2024

(30) Foreign Application Priority Data
Jan. 5, 2024 (CN) 202410022349.9

(51) Int. Cl. G06F 3/14; G06F 3/04845; G06F 3/16; G06F 40/30; G06T 11/00; G10L 15/18

(52) U.S. Cl. CPC G06F 3/1446; G06F 3/04845; G06F 3/167; G06F 40/30; G06T 11/001; G10L 15/1815; G06T 2200/24

(57) ABSTRACT

A media data generation method includes obtaining, by an electronic device through an input module, input information, the input information not being displayed on a screen; and transmitting the input information to a target application running on the screen to generate target media data through the target application, the target media data being at least partially different from content of the input information.

### CROSS-REFERENCE TO RELATED APPLICATION

This application claims priority to Chinese Patent Application No. 202410022349.9, filed on Jan. 5, 2024, the entire content of which is incorporated herein by reference.

### TECHNICAL FIELD

The present disclosure generally relates to the field of computer technologies and, more particularly, to a media data generation method and an electronic device.

### BACKGROUND

In the related art, when media data is being generated, input information and generated data are usually displayed on a same screen, and the operation for generating the media data is complicated, which result in a bad user experience.

### SUMMARY

One aspect of the present disclosure provides a media data generation method, including: obtaining, by an electronic device through an input module, input information, the input information not being displayed on a screen; and transmitting the input information to a target application running on the screen to generate target media data through the target application, the target media data being at least partially different from content of the input information.

Another aspect of the present disclosure provides an electronic device including a memory and a processor. The memory is configured to store a computer program that is able to be executed by the processor. The processor is configured to execute the computer program stored in the memory to enable the electronic device to: obtain, through an input module, input information, the input information not being displayed on a screen; and transmit the input information to a target application running on the screen to generate target media data through the target application, the target media data being at least partially different from content of the input information.

Another aspect of the present disclosure provides an electronic device including a first screen, a second screen, a memory, and a processor. The memory is configured to store a computer program that is able to be executed by the processor. The processor is configured to execute the computer program stored in the memory to enable the electronic device to: obtaining, through an input module, input information, the input information not being displayed on a screen; and transmitting the input information to a target application running on the screen to generate target media data through the target application, the target media data being at least partially different from content of the input information.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those ordinary in the art, other drawings can be obtained based on these drawings without any creative work.

FIG. 1 is a flowchart of a media data generation method consistent with embodiments of the present disclosure.

FIG. 2A is a schematic diagram of a dual-screen first electronic device in a first mode consistent with embodiments of the present disclosure.

FIG. 2B is a schematic diagram of a dual-screen first electronic device in a second mode consistent with embodiments of the present disclosure.

FIG. 2C is a schematic diagram of a dual-screen first electronic device in a third mode consistent with embodiments of the present disclosure.

FIG. 2D is a schematic diagram of a dual-screen first electronic device in a fourth mode consistent with embodiments of the present disclosure.

FIG. 3 is another flowchart of a media data generation method consistent with embodiments of the present disclosure.

FIG. 4 is another flowchart of a media data generation method consistent with embodiments of the present disclosure.

FIG. 5 is another flowchart of a media data generation method consistent with embodiments of the present disclosure.

FIG. 6 is another flowchart of a media data generation method consistent with embodiments of the present disclosure.

FIG. 7 is a schematic structural diagram of a media data generation device consistent with embodiments of the present disclosure.

FIG. 8 is a schematic hardware diagram of an electronic device consistent with embodiments of the present disclosure.

### DETAILED DESCRIPTION OF THE EMBODIMENTS

To make the purpose, technical solution, and advantages of the embodiments of the present disclosure clearer, the technical solution in the embodiments of the present disclosure will be described below in conjunction with the drawings in the embodiments of the present disclosure. The described embodiments are some of the embodiments of the present application, not all of the embodiments. Based on the embodiments in the present disclosure, all other embodiments obtained by those skilled in the art without creative work are within the scope and protection of the present disclosure.

In the following description, reference is made to “some embodiments,” which describe a subset of all possible embodiments, but it will be understood that “some embodiments” may be the same subset or different subsets of all possible embodiments and may be combined with each other when there is no conflict.

In the present disclosure, the terms such as “first,” “second” or “third,” etc., are only used to facilitate the description of different components, and should not be understood as indicating or implying a sequential relationship, relative importance, or implicitly indicating the number of technical features indicated. Therefore, the features associated with “first,” “second,” or “third,” etc., may be interchanged in a specific order or sequence where permitted, so that the embodiments of the present disclosure described herein can be implemented in an order other than that illustrated or described herein.

It can be understood by those skilled in the art that, unless otherwise defined, all terms used herein (including technical terms and scientific terms) have the same meaning as the general understanding of ordinary technicians in the field to which the embodiments of the present disclosure belong. It should also be understood that terms such as those defined in general dictionaries should be understood to have a meaning consistent with the meaning in the context of the art, and will not be interpreted in an idealized or overly formal sense unless specifically defined here.

When media data is being generated, input information and generated data are displayed on a same screen, and the operation for generating the media data is complicated. For example, it is necessary to open an application that generates the media data on the first screen, manually input the input information into the application, and then perform the operation of generating the media data. The operation is relatively complicated, which brings a bad user experience.

The present disclosure provides a media data generation method. On the one hand, input information may be obtained through an input module (e.g., a screen, a sensor, an input component, etc.), which broadens the input information acquisition scenario. On the other hand, the input information may be transmitted to a target application displayed on a first screen to generate media data through the target application. Compared with a method where the input information is first saved or manually imported and then media data is generated in the application on the first screen, the processing efficiency is improved while the user operation is simplified. Further, the first screen and the input module may belong to the same electronic device or different electronic devices, which broadens the application scenario of the media data generation method.

The method provided by the embodiments of the present disclosure may be executed by an electronic device. The electronic device may be a terminal such as a laptop, a tablet computer, a desktop computer, a set-top box, a mobile device (e.g., a mobile phone, a portable music player, a personal digital assistant, a dedicated messaging device, a portable gaming device), or may also be implemented as a server. The server may be an independent physical server, a server cluster, a distributed system including multiple physical servers, or a cloud server that provides basic cloud computing services such as cloud services, cloud databases, cloud computing, cloud functions, cloud storage, network services, cloud communications, middleware services, domain name services, security services, content delivery networks (CDNs), as well as big data and artificial intelligence platforms.

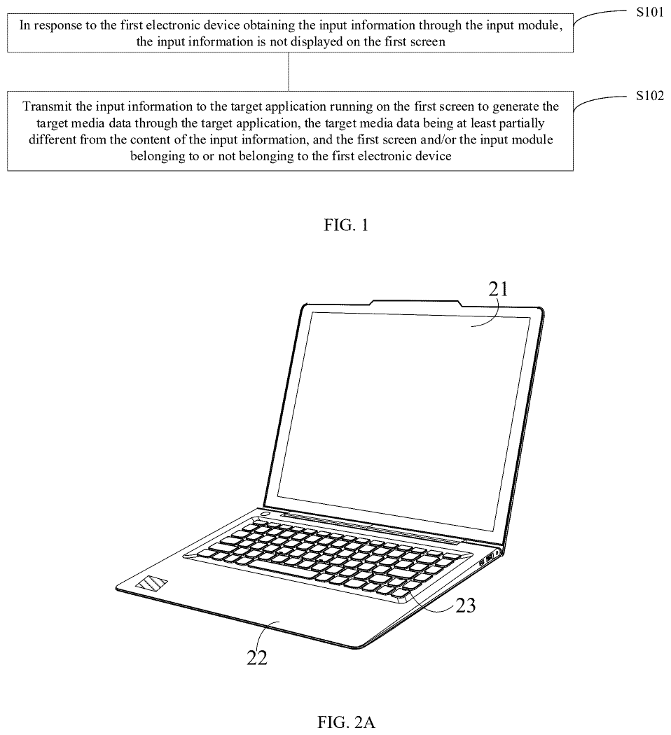

FIG. 1 is a flowchart of a media data generation method consistent with embodiments of the present disclosure. As shown in FIG. 1, in one embodiment, the method includes S101 to S102.

At S101, in response to input information obtained by a first electronic device through an input module, the input information is not displayed on a first screen.

The electronic device may be a device including electronic components such as integrated circuits, transistors, or vacuum tubes, which use electronic technology software to function. The first electronic device may be any suitable device, such as a dual-screen electronic device, a desktop computer, etc. The input module may be a module in the electronic device that is able to obtain the input information. The input module may be any suitable module, such as a screen, a sensor, an input component, etc. The input information may be any suitable information, such as text content, audio content, display parameters, audio parameters, etc.

In some embodiments, the way in which the first electronic device obtains the input information through the input module may include but is not limited to: obtaining the input information through a second screen of the first electronic device or a second electronic device, obtaining the input information through a sensor of the first electronic device or the second electronic device, or obtaining the input information through an input component (such as a keyboard, a stylus, etc.) of the first electronic device or the second electronic device, etc.

At S102, the input information is transmitted to a target application running on the first screen, to generate the target media data through the target application. The target media data may be at least partially different from the content of the input information, and the first screen and/or the input module may or may not belong to the first electronic device.

The target application may be an application for generating the target media data through the input information. The target application may be any suitable application, such as a raw image application, an audio generation application, etc. The target application may process the input information to generate the target media data. In some embodiments, the input module may be a second screen, and the target media data generated on the first screen may be at least partially different from the content of the input information displayed on the second screen. The target media data may be any suitable data, such as image data, audio data, etc. For example, when the input information is the text content of “cat eating fish,” the target media data may be image data composed of cat and fish, and the image data may contain the text content of “cat” and “fish” as annotations.

Transmitting the input information to the target application may include but is not limited to: when the input module is characterized as the second screen, transmitting the input information to the target application through a digital display port (DP), near field communication (NFC), a mobile hotspot, serial communication, etc.; when the input module is characterized as the sensor, transmitting the input information to the target application through a universal serial bus (USB), wireless communication, an intermediary device, etc.; or, when the input module is characterized as the input component, transmitting the input information to the target application through a universal serial bus (USB), wireless communication, an intermediary device, etc. The intermediary device may be any suitable device, such as a microcontroller, an embedded system, etc.

In some embodiments, the target application may generate multiple different target media data based on one input information, and the content of the multiple target media data may be at least partially different from that of the input information.

In some embodiments, the target application may establish a mapping relationship between the generated target media data and the input information, and the mapping relationship may be established based on an identifier of the target media data. The identifier of the target media data may be any suitable symbol, such as the name of the target media data, etc. The identifier of the target media data may be used to represent a certain piece of target media data.

In some embodiments, when the first screen and the second screen belong to the same electronic device, for example, a dual-screen electronic device, the first screen of the electronic device may obtain the input information from the second screen (corresponding to the aforementioned input module) through a digital display port. The digital display port may be used to simultaneously transmit audio information and/or video information, which not only has a high transmission rate but also is reliable and stable.

In some embodiments, when the first screen and the second screen belong to different electronic devices, for example, external screens, the first screen of the electronic device may obtain input information from the second screen through serial communication. Serial communication is a communication method that transmits data serially. It uses two communication lines (transmitter and receiver) for two-way communication. Between the first screen and the second screen, the communication lines of the transmitter and the receiver must be cross-connected to ensure that the data can be transmitted correctly.

In some embodiments, when a sensor is externally connected to the electronic device, a universal serial bus may be used to connect the sensor and the electronic device, and the target application may obtain the input information of the sensor through the universal serial bus.

In some embodiments, when the input module is an input component, the electronic device may receive the encoded data from the input component through a built-in input component driver. Further, the operating system of the electronic device may decode the encoded data into specific input information and transmit the input information to the target application.

In some embodiments, the target application may have an analysis function, and is able to perform semantic analysis and/or sentiment analysis on the input information, and use the analysis results as reference data to generate the media data.

In some embodiments, based on the display parameters or audio parameters of the input information, the display parameters or audio parameters may be used as reference data to generate the media data.

In the present disclosure, on the one hand, the input information may be obtained through the input module (e.g., a screen, a sensor, an input component, etc.), which broadens the input information acquisition scenario. On the other hand, the input information may be transmitted to the target application displayed on the first screen to generate the media data through the target application. Compared with a method with first saving the input information or manually importing the input information and then generating the media data in the application on the first screen, the processing efficiency is improved while the user operation is simplified. Further, the first screen and the input module may belong to the same electronic device or different electronic devices, which broadens the application scenario of the media data generation method.

In some embodiments, obtaining the input information in S101 may include at least one of S101a to S101c.

At S101a, the input information is obtained through the second screen of the first electronic device or the second electronic device, and the second electronic device is a device that establishes a target communication connection with the first electronic device.

In one embodiment, there may be two screens, namely the first screen and the second screen. At this time, the electronic device with the first screen and the electronic device with the second screen may belong to the first electronic device or may not belong to the first electronic device. For example, in a scenario where a dual-screen electronic device is used, the first screen and the second screen may be two screens of the dual-screen electronic device. In this case, the electronic device having the first screen and the electronic device having the second screen may belong to the first electronic device. However, the present disclosure is not limited to this. In a scenario where an external screen is used, the electronic device having the first screen and the electronic device having the second screen may not belong to the first electronic device.

In some embodiments, the input information may be obtained through the second screen of the first electronic device, or through the second screen of the second electronic device. The input information obtained through the second screen of the first electronic device or the second electronic device may be transmitted to the target application at the first screen belonging to the first electronic device, to generate the target media data through the target application.

The way to obtain the input information through the second screen of the electronic device may include but is not limited to: detecting the screen state, capturing the content displayed on the screen, etc. The screen state may be any suitable state, for example, that the screen state changes, that the screen state remains unchanged, etc., and the screen state change may be that the content displayed on the screen is increasing.

In some embodiments, when the first screen and the second screen belong to the first electronic device, the second screen may detect the screen state, and, when the screen state is that the screen state changes, the target application of the first screen may extract the content added to the screen, and then use the content as the input information.

In some embodiments, when the first screen and the second screen do not belong to the first electronic device, the second screen may use the captured part using screenshot or all of the content as the input information.

At S101b, the input information is obtained through a sensor of the first electronic device or the second electronic device, where the second electronic device is a device that establishes a target communication connection with the first electronic device.

In one embodiment, the sensor may be a device for detecting and sensing physical quantities, environmental changes, or specific events. The sensor may convert physical quantities or signals into electrical signals or digital signals such that the information is able to be processed and analyzed. The sensor may include any suitable sensor, such as an audio sensor, a pressure sensor, etc.

In some embodiments, when the sensor detects the content, the content may be converted into an electrical signal or a digital signal, therefore the input information is obtained through the sensor of the first electronic device or the second electronic device. For example, an audio sensor may measure the sound in the environment, convert the measured sound into an electrical signal, and the electrical signal may be used as the input information.

In one embodiment, the input information may be obtained through the sensor of the first electronic device, or the input information may also be obtained through the sensor of the second electronic device. The input information obtained by the sensor of the first electronic device or the second electronic device may be transmitted to the target application at the first screen belonging to the first electronic device to generate the target media data through the target application.

At S101c, the input information is obtained through the input component of the first electronic device or the second electronic device, where the second electronic device is a device that establishes a target communication connection with the first electronic device.

The input component may be any suitable component, such as a keyboard, a mouse, a handle, etc. The first screen and the input module characterized as the input component may belong to the first electronic device or not belong to the first electronic device. For example, in the case where the electronic device is connected to an external keyboard, the first screen and the input module characterized as the input component may not belong to the first electronic device. For another example, in the case where the electronic device has both a handle and a screen built in, the first screen and the input module characterized as the input component may belong to the first electronic device.

The way to obtain the input information through the input component of the electronic device may include but is not limited to: input instruction encoding, parsing and collecting information, etc.

In some embodiments, when the first screen and the input component do not belong to the first electronic device, for example, when the input component is an external keyboard, when the user inputs characters or commands on the keyboard, the keyboard may convert the information into electrical signals, which represent the input data and instructions. The keyboard may include an encoder that is able to convert the electrical signals generated by the keyboard into a data format that the electronic device is able to understand. The encoder may encode the electrical signals input by the keyboard into a specific data sequence and use the data sequence as the input information.

In some embodiments, when the first screen and the input component belong to the first electronic device, for example, when the input component is a handle, the handle may send the collected user operation information (such as buttons, joysticks, etc.) to the controller of the first electronic device. The controller may receive the user operation information, parse and process it, and use the results of the parsing and processing as the input information.

It should be noted that in this embodiment, the input information may be obtained through the input component of the first electronic device, or through the input component of the second electronic device. The input information obtained through the input component of the first electronic device or the second electronic device may be transmitted to the target application running on the first screen of the first electronic device to generate the target media data through the target application.

In the above embodiments, the second electronic device may be a device that establishes a target communication connection with the first electronic device, and the target communication connection may be established through Bluetooth, Wi-Fi, mobile communication technology (such as LTE, 5G, etc.), near field communication (such as NFC, etc.), Zigbee, Z-Wave, etc., to realize specific functions such as data transmission, function expansion, remote control, or auxiliary input between the first electronic device and the second electronic device. The present disclosure does not specifically limit the type of target communication connection, that is, those skilled in the art may adjust its type according to actual conditions, as long as the target communication connection is able to realize data transmission from the second electronic device to the first electronic device.

In the present disclosure, the input information may be obtained through different input components, which broadens the input information acquisition scenario.

In some embodiments, transmitting the input information to the target application running on the first screen in S102 may include at least one of S1021 to S1022.

At S1021, when the input information is obtained through the sensor of the first electronic device, the input information may be converted into reference data used by the target application to generate the media data, and the converted reference data may be transmitted to the target application running on the first screen.

In one embodiment, the sensor may capture various types of data, such as images, sounds, temperature, pressure, light, location information, etc. In the first electronic device, the sensor may include but is not limited to types such as cameras, microphones, GPS, accelerometers, etc.

In some embodiments, the first electronic device may use an information conversion model to convert the input information into the reference data required by the target application when the target media data is being generated. The information conversion model may convert the input information into the reference data required by the target application when the target media data is being generated. This conversion may enable the target application to understand and process the input information more effectively, and then generate the target media data based on the reference data. The information conversion model may be a model deployed locally on the first electronic device, or a cloud model called by the first electronic device. The information conversion model may be an image processing model, a speech recognition model, an environmental data analysis model, etc. The present disclosure does not specifically limit the type of information conversion model, that is, those skilled in the art can adjust its type according to actual conditions, as long as the information conversion model is able to realize the conversion of input information into the reference data required by the target application when the target media data is being generated.

For example, in one possible embodiment, the input information may be image information obtained by a sensor, and the information conversion model may be an image recognition and processing model for extracting features from an image or performing image enhancement. In another possible embodiment, the input information may be sound information obtained by a sensor, and the information conversion model may be a speech recognition model for converting speech into text or commands. In another possible embodiment, the input information may be location information obtained by a sensor, and the information conversion model may be a geographic information processing model for map navigation or location tracking.

In yet another possible embodiment, the input information may be image

information obtained by a light sensor, and the information conversion model may be an image processing model, such as a convolutional neural network (CNN). The information conversion model may extract image features (such as object recognition, scene understanding, etc.) from the image information obtained by the light sensor. The image features extracted by the information conversion model may then be transmitted to the target application, such that the target application may use the reference data of these image features to generate the target media data.

In yet another possible embodiment, the input information may be sound information obtained by a sensor such as a microphone. The information conversion model may be a speech recognition model, such as a recurrent neural network (RNN). The model may be capable of processing sound information, such as transcribing text or extracting audio features. Then, these transcribed texts or extracted sound features may be transmitted to the target application as the reference data, such that the target application may use the reference data of these sound features to generate the target media content related to the sound features.

In another possible embodiment, the input information may be environmental data obtained by environmental sensors (such as temperature and humidity sensors). The information conversion model may be an environmental data analysis model, which may analyze and process these environmental parameters, such as temperature trends and humidity levels. The extracted environmental data may be transmitted to the target application as the reference data to generate an information chart or prediction video related to the environmental data through the target application.

The present disclosure does not specifically limit the specific types of input information and information conversion models. The above embodiments are only used as examples to illustrate what types of input information and information conversion models can exist, but do not limit the scope of the present disclosure.

At S1022, when the input information is obtained by a first application running on the second screen of the first electronic device, the input information obtained in the first application is transmitted to the target application through the target interface between the target application and the first application.

In one embodiment, the first application may be an application for collecting and processing specific types of data, such as a text recording application, a social media application, a news application or another information aggregation application. The first application may obtain the input information from its user interface, and may transmit the input information obtained from the first application to the target application through the first electronic device calling the interface of the target application.

The target interface between the target application and the first application may be able to realize data transmission between the target application and the first application. For example, the target interface may be an application programming interface (API), inter-process communication (IPC), remote procedure call (RPC), message queuing (MQ), web service, shared memory, database interface, etc. The present disclosure does not specifically limit the type of the target interface, that is, those skilled in the art may adjust its type according to the actual situation, as long as the target interface is able to realize data transmission between the target application and the first application.

For example, in one possible embodiment, the first application may be a social media platform. The input information obtained from the first application may include but is not limited to user behavior trends, hot topics or user-generated content. The target application may use this input information as the reference to generate the target media data related to it.

In another possible embodiment, the first application may be a news aggregator, and the input information obtained from the first application may include but is not limited to the latest news or event reports. The target application may use this input information as the reference to generate the target media data related to it.

In another possible embodiment, the first application may be a text recording application, and the input information obtained from the first application may include but is not limited to text information, drawing information, etc. displayed on the text recording application interface. The target application may also use this input information as the reference to generate the target media data related thereto.

It should be noted that the present disclosure does not specifically limit the specific type of the first application. The above embodiments are used as examples only to illustrate the types of the first application, but do not limit the scope of the present disclosure.

In the present disclosure, the reference data or input information may be received by the target application, and the process of transmitting the input information to the target application may be refined in different application scenarios, thereby improving the accuracy of transmitting the input information.

In some embodiments, S102 may include one of S11 to S14.

At S11, semantic analysis is performed on the input information by the target application, and the obtained semantic analysis results is used as the reference data to generate the target media data.

In one embodiment, semantic analysis may be performed by natural language processing (NLP) to extract semantic information from the input information and obtain semantic analysis results, such that the electronic device is able to understand the meaning of the text. Semantic analysis may be divided into lexical level semantic analysis and sentence level semantic analysis. Methods for implementing semantic analysis may include but are not limited to statistical learning methods, deep learning methods, etc. Statistical learning methods may be methods based on probability models, which train a large number of samples such that the electronic device is able to understand the meaning of the input information. Deep learning methods may be methods based on neural networks, which train a large number of samples such that the electronic device is able to understand the meaning of the input information.

In some embodiments, when the semantic analysis is lexical level semantic analysis, semantic analysis may be implemented by word sense disambiguation and word semantic similarity calculation. Word sense disambiguation is one of the basic problems in natural language processing, which is used to learn the multiple meanings of a word and confirm a certain meaning corresponding to the word according to the current context. The semantic similarity of words refers to the degree to which two words are able to be used interchangeably in different contexts without changing the syntactic and semantic structure of the text. During implementation, the semantic analysis results may be obtained through word sense disambiguation or word semantic similarity calculation, and the semantic analysis results may be used as the reference data to generate the target media data.

In some embodiments, when the semantic analysis is sentence-level semantic analysis, semantic analysis may be achieved through shallow semantic analysis or deep semantic analysis. Shallow semantic analysis mainly revolves around the predicates in the sentence, and finds the corresponding semantic role for each predicate. The predicates are the main words in the predicate part of the sentence, and represent the properties of an individual and the relationship between two or more individuals in mathematical logic. Deep semantic analysis converts the entire sentence into a formal representation. During implementation, through the semantic role labeling (SRL) of shallow semantic analysis, the corresponding semantic role components of the predicates in the sentence may be found, including core semantic roles (such as agent, patient, etc.) and subsidiary semantic roles (such as place, time, method, reason, etc.), and the entire sentence may be converted into a formal representation through deep semantic analysis to obtain the semantic analysis result. The semantic analysis result may be used as the reference data to generate the target media data.

At S12, sentiment analysis is performed on the input information through the target application, and the obtained sentiment analysis result is used as the reference data to generate the target media data.

In one embodiment, sentiment analysis may be the main content of natural language processing, and subjective input information with emotional color may be analyzed, processed, summarized and reasoned. Methods for implementing sentiment analysis may include but are not limited to keyword recognition, statistical methods, concept-level technology, etc. Keyword recognition may use clearly defined influence words appearing in the text, such as “happy,” “sad,” “afraid,” “bored,” etc., to influence the sentiment analysis results. Statistical methods may perform potential semantic analysis to influence the sentiment analysis results. Concept-level technology may deeply analyze the input information and obtain more subtle emotional expressions in the input information, for example, analyzing some input information that does not clearly express relevant content.

In some embodiments, sentiment analysis may be achieved by preprocessing the input information, extracting features, and using trained models. The trained models may include a model composed of emotional words such as positive words, negative words, negative words, and degree adverbs. First, the input information may be preprocessed, including removing punctuation marks, etc., to simplify the input information for subsequent analysis. Secondly, key information in the input information may be extracted as the features of the input information, such as themes, viewpoints, etc. Then, the overall emotional tendency of the features of the input information may be judged by the trained model, and the emotional analysis result may be obtained. The emotional analysis result may be used as the reference data to generate the target media data.

At S13, based on the display parameters of the input information, the display parameters are used as the reference data to generate the target media data.

In one embodiment, the display parameters may be any suitable parameters, such as color, transparency, hue, resolution, screen refresh rate, etc. In some embodiments, according to the display parameters in the input information, the transparency, color, refresh rate, etc. of the target media data may be determined. The display parameters may determine the basic features of the target media data. The basic features of the target media data may include but are not limited to the transparency, color, refresh rate, etc. of the target media data. When the target media data is being generated, the basic features of the target media data may correspond to the display parameters. For example, when the display parameters include the parameter “yellow,” the color of the target media data may also be yellow.

At S14, based on the audio parameters of the input information, the target media data is generated using the audio parameters as the reference data.

In one embodiment, the audio parameters may be any suitable parameters, such as frequency, timbre, channel, sampling rate, bit depth, etc. In some embodiments, the frequency, timbre, channel, sampling rate, bit depth, etc. of the target media data may be determined based on the audio parameters of the input information. The audio parameters may determine the basic characteristics of the target media data, and the basic characteristics of the target media data may include but are not limited to the frequency, timbre, channel, sampling rate, bit depth, etc. of the target media data. When the target media data is being generated, the basic characteristics of the target media data may correspond to the audio parameters. For example, the audio parameters may include the parameter “500 Hz (Hertz),” and correspondingly, the frequency of the target media data may also be 500 Hz.

In the embodiments of the present disclosure, the target media data may be generated based on the semantic analysis results, sentiment analysis results, display parameters, or audio parameters, thereby improving the accuracy of the generated media data.

In some embodiments, S102 may include S21 to S24.

At S21, when the input information includes text content, semantic analysis and/or sentiment analysis is performed on the text content, and at least one of the semantic theme features, content categories, or sentiment features obtained by the analysis are used as the reference data to generate the target media data.

In one embodiment, the text content may indicate that the input information

includes text information. The semantic theme feature may be a theme feature corresponding to the characterization text content in the text content, such as humans, flowers, etc. The content category may be a category corresponding to the characterization text content in the text content, such as animals, plants, etc. The sentiment feature may be a sentiment feature corresponding to the characterization text content in the text content, such as happy, sad, angry, etc. When performing semantic analysis or sentiment analysis on the text content, semantic analysis may be performed first, or sentiment analysis may be performed first. For the method for performing semantic analysis and/or sentiment analysis on the text content, references may be made to S11 and/or S12.

For example, when the current text content is “There is a very happy kitten here, and this kitten is eating fish,” the text content may be subjected to semantic analysis and sentiment analysis, and the semantic theme features of the text content are cats and fish, the content category is animals, and the sentiment feature is happy. The semantic theme features, content category and/or sentiment features of the text content may be used as the reference data to generate the target media data. There may be many possible situations for the generated target media data:

For example, in one possible situation, the generated target media data may be a picture, which may express a scene where an anthropomorphic kitten is smiling happily, holding a fish in its hand, and has fish scales on its mouth. This kind of picture may be designed by the target application using an image generation algorithm, combined with the above reference data, to match the scene and emotional expression described in the text.

In another possible situation, the generated target media data may also be a video, which may express the scene of a kitten eating fish happily through animation. For example, in the video, the kitten may jump and fiddle with the fish under the brisk music, and show a happy expression of enjoying food. This video may transform the semantic themes, content categories, and emotional features of the text into dynamic images and sounds, providing a more vivid and attractive content experience.

In another possible case, the generated target media data may also be audio, which may express the sound of a kitten happily eating fish, such as the chewing sound when eating fish, the satisfied meowing sound, etc. This audio may capture and emphasize the emotional features in the text, and bring an immersive experience to the audience through the warmth and rhythm of the sound.

In the above way, the semantic theme features, content categories, or emotional features of the text content may be understood and analyzed, and may be transformed into specific and diversified target media data, which may be presented to users in different forms, enriching the user's sensory experience, and may effectively convey the information and emotions contained in the original text.

S22, when the input information includes audio content, semantic analysis and/or sentiment analysis is performed on the audio content, and at least one of the semantic theme features, sentiment features or audio parameters obtained by the analysis are used as the reference data to generate the target media data.

In one embodiment, the audio content may indicate that the input information is audio information. The semantic theme features may be theme features corresponding to the characterization audio content in the audio content, such as flowers, girls, etc. The content category may be a category corresponding to the characterization audio content in the audio content, such as plants, animals, etc. The sentiment feature may be a sentiment feature corresponding to the characterization audio content in the audio content, such as lightheartedness, sadness, etc. When performing semantic analysis and sentiment analysis on the audio content, semantic analysis may be performed first, or sentiment analysis may be performed first. For the method of performing semantic analysis and/or sentiment analysis on the audio content, references may be made to the aforementioned S11 and/or S12.

For example, when the current audio content is “a little girl fell and cried sadly,” the audio content may be subjected to semantic analysis and sentiment analysis, and the semantic theme features of the audio content are analyzed may be girl and falling, the content category may be animal, and the sentiment feature may be sad. At least one of the semantic theme features, content category, and sentiment features of the audio content may be used as the reference data to generate the target media data. The generated target media data type may be similar or identical to the target media data type generated in the aforementioned S21, the description of which will not be repeated here.

S23, when the input information includes the display parameters of the input content, at least one of color, transparency or tone of the display parameters is used as the reference data to generate the target media data.

In one embodiment, the display parameters may determine the basic features of the target media data. When the target media data is being generated, the basic features of the target media data may correspond to the display parameters. For example, when the current input information is a picture, the content of the picture may represent the content of “a yellow puppy with a transparency of 30%.” At this time, the display parameters may include yellow and/or 30% transparency, and the target application may use at least one of the color and transparency of the display parameter as the reference data to generate the target media data. The generated target media data may also be target media data of yellow and/or 30% transparency.

S24, when the input information includes audio parameters of the input voice, at least one of the frequency, timbre and channel of the audio parameter is used as the reference data to generate the target media data.

In one embodiment, the audio parameters may determine the basic characteristics of the media data. When the target media data is being generated, the basic characteristics of the media data may correspond to the audio parameters. For example, when the current input information is an audio segment, the audio content may represent the content of “piano music, frequency of 600-700 Hz, played in two channels.” At this time, the frequency of the audio parameters may be 600-700 Hz, the timbre may be beautiful voice, and the channel may be two channels. At least one of the frequency, timbre and channel of the audio parameter may be used as the reference data to generate the target media data.

In the present disclosure, different contents or parameters corresponding to the input information may correspond to a variety of different reference data. Therefore, the process of generating the target media data using reference data may be refined, thereby improving the accuracy of generating the media data.

In some embodiments, the method may further include:
S103, based on the obtained reference data, updating the target application.

In one embodiment, the reference data may be any suitable data, such as emotional features, semantic theme features, colors, etc. The method for updating the target application may include but is not limited to machine learning, deep learning, etc. For example, machine learning may refer to a method of optimizing and updating the target application using the reference data. After obtaining the multiple reference data, the reference data set may be determined, and feature extraction, selection, and conversion may be performed on the reference data set. The target application may be trained using a suitable machine learning algorithm, and the target application may be updated. Machine learning algorithms may include but are not limited to decision trees, support vector machines, neural networks, etc. When selecting an algorithm, linear regression, decision trees, and other algorithms may be used for regression problems; or, support vector machines, neural networks, and other algorithms may be used for classification problems. For another example, deep learning may refer to updating the target application by learning the inherent laws and representation levels of the reference data. After obtaining the multiple reference data, the reference data set may be determined, and the reference data set may be preprocessed, such as by normalization or feature scaling. The target application may be trained using a suitable deep learning model, and the target application may be updated. Deep learning models may include but are not limited to convolutional neural networks, recurrent neural networks, etc. When selecting a model, a recurrent neural network may be selected for sequence data, and a convolutional neural network may be selected for segmentation, classification, and detection of image data.

In some embodiments, when the input information includes text content, semantic analysis and/or sentiment analysis may be performed on the text content, and at least one of the semantic theme features, content categories, and sentiment features of the text content obtained by analysis may be used as the reference data, and a suitable algorithm may be used to train the target application and update the target application.

In some embodiments, when the input information includes audio content, semantic analysis and/or sentiment analysis may be performed on the audio content, and at least one of the semantic theme features, sentiment features, or audio parameters of the audio content obtained by analysis may be used as the reference data, and a suitable algorithm may be used to train the target application and update the target application.

In some embodiments, when the input information includes the display parameters of the input content, at least one of the color, transparency, and hue of the display parameters may be used as the reference data, and a suitable algorithm may be used to train the target application and update the target application.

In some embodiments, when the input information includes input speech audio parameters, at least one of the frequency, timbre, and channel of the audio parameters may be used as the reference data, and a suitable algorithm may be used to train the target application and update the target application.

In the present disclosure, the target application may be updated based on the reference data, which may make the target application more intelligent. In the process of continuous updating of the target application, more reference data may be obtained, and the speed of generating the media data based on the reference data may be improved.

In some embodiments, S102 may include at least one of S31 to S35.

At S31, in response to the input information being in the inputting state, the obtained input information is transmitted to the target application at a preset time interval.

In one embodiment, the inputting state may represent that the input module is in a working state at this time, for example, the sensor is detecting and sensing physical quantities, the keyboard is working, the cursor of the input text page is flashing, etc. The preset time interval may be any appropriate time, for example, 10 s (seconds), 1 minute, etc. When the preset time interval is reached, the obtained input information may be transmitted from the input module to the target application. The way of transmitting the input information from the input module to the target application may refer to S102.

At S32, in response to the input information switching from the inputting state to the input completion state, the obtained input information in the input completion state is transmitted to the target application.

In one embodiment, the input completion state may indicate that the input module is in a non-working state at this time, for example, the sensor completes the detection and perception of the physical quantity, the screen state of the second screen does not change, the cursor of the input text page disappears or no longer flashes, etc. When the input information is switched from the inputting state to the input completion state, the obtained input information may be transmitted from the input module to the target application. The way in which the input information is transmitted from the input module to the target application may refer to the specific implementation of S102.

At S33, in response to the target operation on the input information, the input information selected by the target operation is transmitted to the target application.

In one embodiment, the target operation may be any suitable operation, for example, selecting part of the content displayed on the second screen, extracting the content detected by the sensor, etc. The target operation may be implemented by methods such as regional screenshots or information extraction. For example, a regional screenshot of the content displayed on the second screen may be performed to complete the target operation. For another example, information extraction may be performed on all the content detected by the sensor to obtain part of the content detected by the sensor, and the target operation may be completed.

At S34, in response to the change in the form of the first electronic device, the input information obtained by the first electronic device before the form change is transmitted to the target application.

In one embodiment, the change in the form of the electronic device may refer to the change in the appearance of the electronic device, and the form change may be any suitable change, such as folding, opening, telescoping, etc. For example, the form change may be a mode conversion of a dual-screen electronic device, a screen change of a folding screen, etc. The modes of the dual-screen electronic device may include but are not limited to a first mode, a second mode, a third mode, a fourth mode, etc. The first mode may represent that the dual-screen electronic device is in a notebook form; the second mode may represent that the dual-screen electronic device is in a book form; the third mode may represent that the dual-screen electronic device is in a tent form; and the fourth mode may represent that the dual-screen electronic device is in a tablet form. For example, when the dual-screen electronic device changes from the fourth mode to the second mode, the form of the dual-screen electronic device may change from the folded state of the tablet to the opened state of the book.

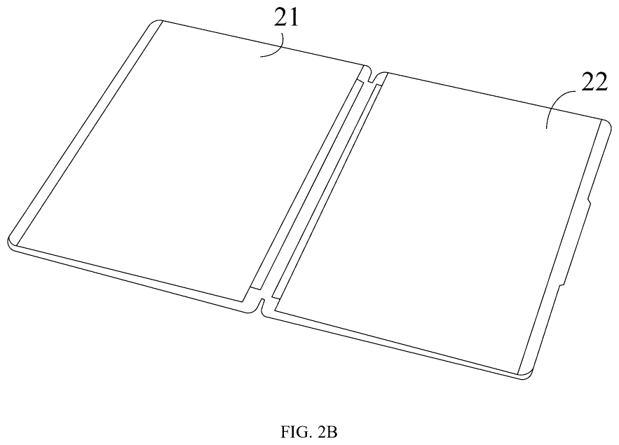

FIG. 2A is a schematic diagram of a dual-screen electronic device in the first mode provided by an embodiment of the present disclosure. As shown in FIG. 2A, the dual-screen electronic device 20 includes a first screen 21 and a second screen 22. A keyboard 23 may be mounted on the second screen 22, where the first screen 21 and the second screen 22 may be in a vertical relationship.

FIG. 2B is a schematic diagram of a dual-screen electronic device in a second mode provided by an embodiment of the present disclosure. As shown in FIG. 2B, the dual-screen electronic device 20 includes a first screen 21 and a second screen 22, where the first screen 21 and the second screen 22 may be in a left-right relationship.

FIG. 2C is a schematic diagram of a dual-screen electronic device in a third mode provided by an embodiment of the present disclosure. As shown in FIG. 2C, the dual-screen electronic device 20 includes a first screen 21 and a second screen 22, where the first screen 21 and the second screen 22 may be in a vertical relationship.

FIG. 2D is a schematic diagram of a dual-screen electronic device in a fourth mode provided by an embodiment of the present disclosure. As shown in FIG. 2D, the dual-screen electronic device 20 includes a first screen 21. The first screen 21 may be split to obtain a first left screen and a first right screen.

When the form of the electronic device changes, for example, in the book mode of the dual-screen electronic device, the input information may be obtained from the second screen 22. When the dual-screen electronic device is converted from the book mode to the tablet mode, the target application may be displayed on the first left screen of the first screen 21, and the second screen 22 may transmit the obtained input information to the first screen 21.

At S35, in response to the first electronic device establishing a communication connection with the second electronic device, the input information obtained by the first electronic device may be transmitted to the target application.

In one embodiment, in the scenario of interconnected devices, the first electronic device and the second electronic device may establish a communication connection through a serial communication interface, a wireless communication protocol, a bus structure, etc. A serial communication interface is an interface standard for communication between an electronic device and a terminal device, such as RS-232, RS-485, etc. Through a serial communication interface, an electronic device and a terminal device may achieve a point-to-point communication connection. A wireless communication protocol is used to achieve a communication connection between devices in a wireless environment, such as Bluetooth, a mobile communication network, etc., and an electronic device and a terminal device may establish a communication connection through a wireless communication protocol to achieve the transmission of input information. A network protocol is a rule and standard for communication between different network devices, such as a transmission control protocol (TCP), a hypertext transfer protocol (HTTP), etc., and a communication connection may be established between the first electronic device and the second electronic device through a network protocol to achieve the transmission of input information.

In the present disclosure, the input information may be transmitted to the target application based on different states of input information, target operations, changes in the shape of the first electronic device, or a communication connection established between the first electronic device and the second electronic device, thereby enriching the various scenarios for transmitting input information and improving the accuracy of transmitting the input information to the target application.

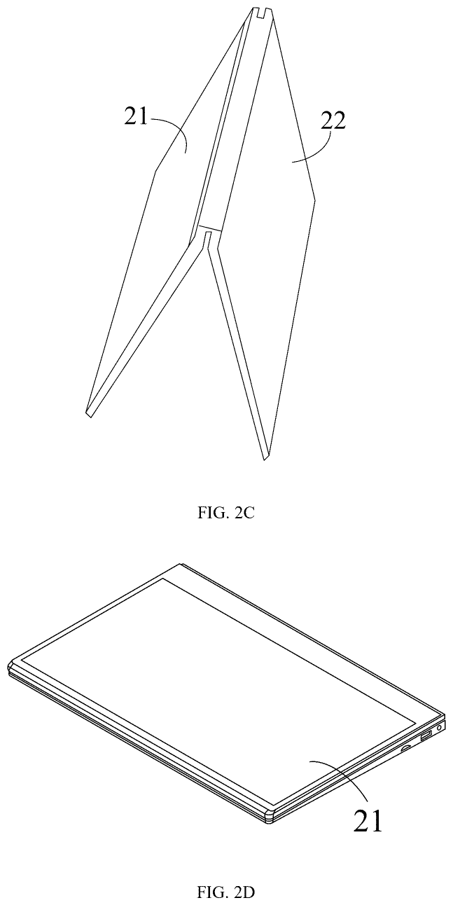

FIG. 3 is a flowchart of a media data generation method provided by another embodiment of the present disclosure. As shown in FIG. 3, the input module includes a second screen, and the method includes S301 to S304.

At S301, in response to the first electronic device obtaining the input information through the input module, the input information is not displayed on the first screen. The first electronic device can obtain the input information through the input module, and the input information is not displayed on the first screen.

At S302, the input information is transmitted to the target application running on the first screen to generate the target media data through the target application. The target media data may be at least partially different from the content of the input information, and the first screen and/or the input module may belong to or not belong to the first electronic device.

S301 to S302 correspond to S101 to S102 respectively, and when implementing, references may be made to the implementation of S101 to S102.

At S303, in response to the selection operation on the target media data displayed on the first screen, the input information corresponding to the selected media data is distinctively displayed on the second screen, and/or the target media data is regenerated on the first screen based on the selected media data.

The target media data displayed on the first screen may be any suitable data, such as image data, audio data, etc. The input information displayed on the second screen may be any suitable information, such as text content, audio content, graphic content, etc. The content of the target media data displayed on the first screen may be at least partially different from the content of the input information displayed on the second screen. The selection operation on the target media data may be an operation of selecting one or more media data from the target media data displayed on the first screen, and the selection operation may be any suitable operation, such as a selection operation through a keyboard, a selection operation through a cursor, etc. The differentiated display may mean that on the second screen, the input information corresponding to the selected media data is displayed distinctively from other input information, and the display mode may be any suitable mode, such as bold display, highlight display, etc. The input information corresponding to the target media data may be determined by a mapping relationship between the target media data and the input information, and the input information corresponding to the selected media data may be determined by the mapping relationship. In some embodiments, the content of the selected media data regenerated on the first screen may be at least partially different from the content of the target media data originally displayed on the first screen.

In some embodiments, when regenerating the selected media data, the target application may re-establish the mapping relationship between the generated selected media data and the input information, and the mapping relationship may be established based on the identifier of the target media data, and the identifier of the target media data may be any suitable symbol, for example, the name of the target media data, etc.

At S304, in response to the selection operation on the input information displayed on the second screen, the media data corresponding to the selected input information is distinctively displayed on the first screen, and/or the target media data corresponding to the selected input information is regenerated on the first screen.

The target media data displayed on the first screen may be any suitable data, for example, image data, audio data, etc., and the input information displayed on the second screen may be any suitable information, for example, text content, audio content, graphic content, etc. The content of the target media data displayed on the first screen may be at least partially different from that of the input information displayed on the second screen. The selection operation on the input information may be an operation of selecting input information from the input information displayed on the second screen, and the selection operation may be any suitable operation, for example, a selection operation through a keyboard, a selection operation through a cursor, etc. Distinctive display may mean that on the first screen, the target media data corresponding to the selected input information is displayed distinctively from other target media data, and the display mode may be any suitable mode, such as bold display, highlight display, etc. The target media data corresponding to the input information may be determined by the mapping relationship between the input information and the target media data, and the target media data corresponding to the selected input information may be determined by the mapping relationship. In some embodiments, the selected target media data regenerated on the first screen may be at least partially different from the target media data originally displayed on the first screen.

In the present disclosure, the target media data or input information may be highlighted through different selection operations, and the target media data may be regenerated, such that the user may find the target media data corresponding to the input information, thereby optimizing the user experience.

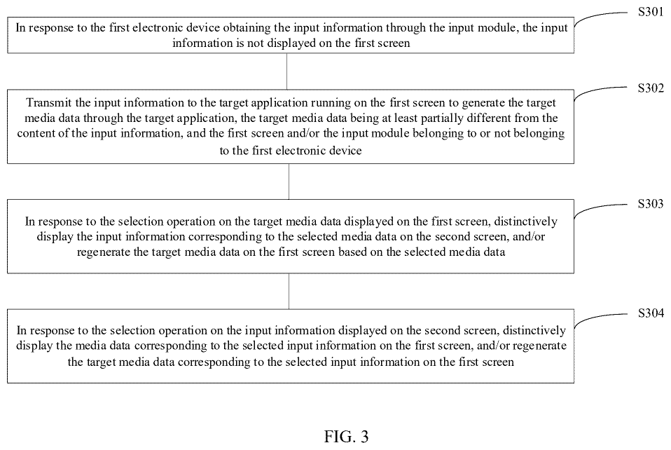

FIG. 4 is a flowchart of a method for generating media data provided by another embodiment of the present disclosure. As shown in FIG. 4, the method includes S401 to S403.

At S401, in response to the first electronic device obtaining the input information through the input module, the input information is not displayed on the first screen.

At S402, the input information is transmitted to the target application running on the first screen to generate the target media data through the target application. The target media data may be at least partially different from the content of the input information, and the first screen and/or the input module may belong to or not belong to the first electronic device.

S401 to S402 correspond to S101 to S102 respectively, and when implementing, references may be made to the implementation of S101 to S102.

At S403, based on the type and/or amount of the target media data, the target output module for outputting the target media data is determined and the target media data is output through the corresponding target output module. The target output module may include at least one of the following: a display output module or an audio output module.

The type of the target media data may be any suitable type, such as image, audio, text, etc. The number of target media data may be any suitable number, such as 1, 3, 4, etc. The display output module may output video data, image data, text, etc., and the display output module may be any suitable module, such as a screen, a projector, etc. The audio output module may output audio data, and the audio output module may be any suitable module, such as a speaker, a headset, etc. Exemplarily, when the target media data includes the image data, a display output module may be determined as a target output module, and the image data may be output through the target output module.

In some embodiments, when outputting image data or video data through the display output module, the image data or video data may need to be preprocessed before display, such as scaling, filtering, color adjustment, etc., to adapt to the configuration parameters of the display output module.

In some embodiments, when outputting target media data through the display output module, the preprocessed image data or video data may be encoded. Further, the encoded image data or video data may be sent to a display driver IC (DDIC) of the display output module. After receiving the encoded target media data, the display driver IC may convert the encoded target media data into a format suitable for the target media data of the display output module, and then output the target media data in the display output module.

In some embodiments, when outputting audio data through the audio output module, the audio data may be preprocessed before output, such as equalization, noise reduction, volume adjustment, etc., to meet user needs.

In some embodiments, when outputting audio data through the audio output module, the pre-processed audio data may be encoded, and the encoding method may include but is not limited to pulse code modulation (PCM), advanced audio coding (AAC), etc. Further, the encoded audio data may be converted into an analog signal, and a digital-to-analog converter (DAC) in the audio output module may convert the digital audio signal into an analog audio signal. Then, the analog audio signal may be output through an amplifier in the audio output module.

In the present disclosure, the target output module may be determined based on the type and/or amount of the target media data, which improves the accuracy of the output of media data by the electronic device in a scenario including multiple output modules.

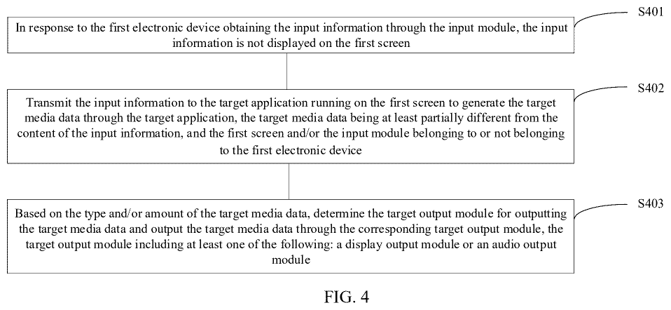

FIG. 5 is a flowchart of a method for generating media data provided by another embodiment of the present disclosure. As shown in FIG. 5, the method includes S501 to S505.

At S501, in response to the first electronic device obtaining the input information through the input module, the input information is not displayed on the first screen.

At S502, the input information is transmitted to the target application running on the first screen to generate the target media data through the target application. The target media data may be at least partially different from the content of the input information, and the first screen and/or the input module may belong to or not belong to the first electronic device.

S501 to S502 correspond to S101 to S102 respectively, and when implementing, references may be made to the implementation of S101 to S102.

At S503, the configuration parameters of the target output module are obtained.

The configuration parameters of the target output module may be used to characterize the characteristics of the target output module, and the configuration parameters may be any suitable parameters. For example, for a display output module, the configuration parameter may be at least one of resolution, bit depth, color format, color space, etc. For another example, for an audio output module, the configuration parameter may be at least one of channel parameters, sampling rate, bit depth, etc.

At S504, based on the configuration parameters, the attribute information of the target media data corresponding to the target output module is adjusted to the attribute information matching the configuration parameters.

The target output module may include at least one of a display output module or an audio output module. The attribute information of the target media data may be any suitable information. For example, for a display output module, the attribute information may be at least one of resolution, bit depth, color format, color space, etc. For another example, for an audio output module, the attribute information may be at least one of channel parameters, sampling rate, bit depth, etc.

In some embodiments, when the target output module includes a display output module, at least one attribute information of the resolution, bit depth, color format, and color space of the target media data may be adjusted to attribute information matching the configuration parameters based on at least one configuration parameter of the resolution, bit depth, color format, and color space of the display output module.

In some embodiments, when the target output module includes an audio output module, at least one attribute information of the channel parameter, sampling rate, and bit depth of the audio output module may be adjusted to attribute information matching the configuration parameters based on at least one configuration parameter of the channel parameter, sampling rate, and bit depth of the audio output module.

At S505, based on the type and/or amount of the target media data, the target output module that outputs the target media data is determined and the target media data is output through the corresponding target output module. The target output module may include at least one of a display output module or an audio output module.

S505 corresponds to the S403, and for the specific implementation, reference can be made to S403.

In the present disclosure, the attribute information of the target media data may be adjusted based on the configuration parameters of the target output module, such that the output of the target media data may adapt to the target output module, thereby improving the accuracy of the output media data and providing users with a better user experience.

In some embodiments, S503 includes S51 to S56.

At S51, when the target media data includes an image, the image is output to the first screen or to the second screen or third screen of the second electronic device. The display output module may be any suitable module, such as a screen, a projector, etc. For the process of outputting the image data through the display output module, references may be made to the implementation of the aforementioned S403.

At S52, when the target media data includes multiple images, the multiple images are output to the first screen in sequence according to a preset time interval, or output to the second screen or third screen of the second electronic device.

The contents of the multiple image data may be at least partially different. The preset time interval may be any suitable time, such as 10 s, 5 s, etc. When the preset time interval is reached, each of the multiple image data may be output in sequence through the display output module. For the process of outputting the image data through the display output module, references may be made to the implementation of the aforementioned S403.

At S53, when the target media data includes audio data, the audio data is output through the audio output module of the first electronic device and/or the second electronic device.

The audio output module may output audio data, and the audio output module may be any suitable module, such as a speaker, earphone, etc. For the process of outputting audio data through the audio output module, references may be made to the implementation of the aforementioned S403.

At S54, when the target media data includes audio data, the audio data is output through the audio output module of the first electronic device and/or the second electronic device, and the image data generated based on the audio data is output through the display screen of the first electronic device and/or the second electronic device.

The audio output module may output audio data, and the audio output module may be any suitable module, such as a speaker, earphone, etc. The audio data may be used as reference data. Based on the audio parameters of the audio data, at least one of the frequency, timbre and channel of the audio parameters may be used as the reference data to generate the image data. For the process of outputting audio data through the audio output module, references may be made to the implementation of the aforementioned S403. For the process of generating the image data using audio data as the reference data, references may be made to the implementation of the aforementioned S14. For the process of outputting the image data through the display output module, references may be made to the implementation of the aforementioned S403.

At S55, when the target media data includes image data and audio data, the audio data may be output through the audio output module of the first electronic device and/or the second electronic device, and the image data may be output through the display screen of the first electronic device and/or the second electronic device.

The audio output module may output audio data, and the audio output module may be any suitable module, such as a speaker, earphone, etc. The display output module may be any suitable module, such as a screen, a projector, etc. For the process of outputting audio data through the audio output module, references may be made to the implementation of the aforementioned S403. For the process of outputting the image data through the display output module, references may be made to the implementation of the aforementioned S403.

At S56, when the target media data includes image data, the image data may be converted into audio data describing the image data, to be output through the audio output module of the first electronic device and/or the second electronic device.

The audio output module may output audio data, and the audio output module may be any suitable module, such as a speaker, earphone, etc. The way of converting image data into audio data describing image data may include but is not limited to image preprocessing, feature extraction, data encoding, etc. For the process of outputting audio data through the audio output module, references may be made to the implementation of the aforementioned S403. For the process of outputting the image data through the display output module, references may be made to the implementation of the aforementioned S403.

In some embodiments, the image data may be converted into a grayscale image through image preprocessing. Then, feature points may be extracted from the image data through feature extraction, and the feature extraction method may include but is not limited to Histogram of Oriented Gradient (HOG), Local Binary Pattern (LBP), etc. For example, through HOG, the image data may be divided into small connected areas, and then the gradient or edge direction histograms of each pixel in the connected area may be collected, and these histograms may be combined to obtain multiple feature points and image features. Subsequently, the extracted image features may be encoded into audio data through an audio generation algorithm, and the audio generation algorithm may include but is not limited to Linear Predictive Coding (LPC), Fourier transform, etc. For example, through LPC, the feature points may be converted into distinctive equations, and then the sum of squares of the difference between the actual sampling and the linear prediction sampling may be locally minimized to obtain audio data.

At S51 to S56, the image may be output through the display module, and the display module may be the first screen, the second screen of the second electronic device, the third screen of the second electronic device, or the N-th screen of the second electronic device, etc. The present disclosure does not specifically limit the display module used to output the image, that is, the technicians in this field may adjust its type according to the actual situation.

At S51 to S56, the audio module may be the audio module of the first electronic device, or the audio module of the second electronic device, and the audio module may be multiple audio modules in the first electronic device or the second electronic device, or one audio module in the first electronic device or the second electronic device. The present disclosure does not specifically limit the type of the audio module, that is, the technicians in this field may adjust its type according to the actual situation.

In the present disclosure, different output modes may be selected based on

different target media data, and for the generated target media data, the operation of regenerating the target media data may be performed, which is compatible with multiple scenarios of the media data generation method and optimizes the process of outputting media data.

The following describes the application of the media data generation method provided by the embodiments of the present disclosure in an actual scenario, and the generation of image data by a dual-screen electronic device (corresponding to the aforementioned first electronic device) will be used as an example.

When media data is being generated, the input information and the generated data are displayed on the same screen, and the operation for generating the media data is complicated. For example, it is necessary to open the application for generating the media data on the first screen, manually input the input information into the application, and then perform the operation of generating media data. The operation is relatively complicated, which brings a bad user experience.

The present disclosure provides a media data generation method, which obtains input information through the screen, transmits the input information to the target application displayed on the first screen, and generates the media data through the target application. Compared with the existing technologies where the input information needs to be saved first or manually imported into the first screen and then the media data is generated in the application on the first screen, while simplifying the user operation, the processing efficiency may be also improved, which may bring a better user experience to the user.

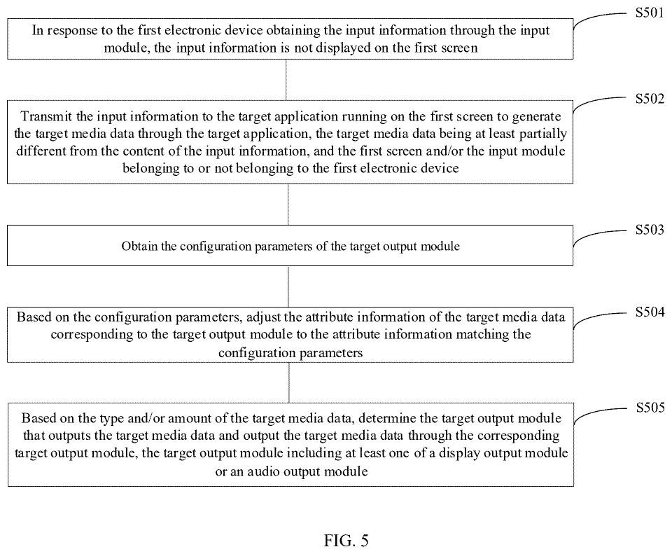

FIG. 6 is a flowchart of a media data generation method provided by an embodiment of the present disclosure. As shown in FIG. 6, the method includes S601 to S604.

At S601, the second screen of the dual-screen electronic device obtains and displays input information.

At S602, the input information is transmitted to the target application displayed on the first screen, to generate image data through the target application and display the image data on the first screen.

At S603, when the mode of the dual-screen electronic device changes, the attribute information of the image data is changed based on the configuration parameters of the first screen after the mode change.

When the mode of the dual-screen electronic device changes, it may mean that the shape of the dual-screen electronic device changes, and the shape change may be any suitable change, such as folding, opening, etc. The mode of the dual-screen electronic device may include but is not limited to a notebook mode (corresponding to the aforementioned first mode), a book mode (corresponding to the aforementioned second mode), a tent mode (corresponding to the aforementioned third mode), a tablet mode (corresponding to the aforementioned fourth mode), etc. For example, when the dual-screen electronic device changes from the tablet mode to the book mode, the shape of the dual-screen electronic device may change from the folded state to the open state. The configuration parameters of the first screen may include but are not limited to resolution, image ratio, color format, color space, etc.

When the mode of the dual-screen electronic device changes, the attribute information of the image data may also change according to the configuration parameters of the first screen of the changed mode. For example, when the dual-screen electronic device changes from the book mode to the notebook mode, the image ratio may change from 9:16 to 16:9. Here, when the image ratio changes from 9:16 to 16:9, the image expansion technology may be used to expand the image into an image with similar content, but richer content above and below and reduced content on the left and right. The image may be expanded by extracting and reconstructing elements.

In some embodiments, by circling the notes on the second screen, the media data (e.g., thumbnails, etc.) may be generated and directly displayed on the first screen and the angle of the thumbnails may be rotated to facilitate face-to-face demonstrations.

In some embodiments, by selecting the input information in the first application (e.g., a document editing application, etc.), the media data (e.g., thumbnails, etc.) may be generated on the first screen and the selected input information may be displayed through their respective display modules, which is convenient for comparison between the two.

In some embodiments, the selected generated image data may be directly linked to the corresponding input information, and the generated image data may be regenerated and replaced.

The present disclosure does not specifically limit the application scenario of the media data generation method, that is, those skilled in the art may adjust its type according to actual conditions. The above embodiments are used as examples only to illustrate the forms in which the media data generation method in the present disclosure may be applied, but do not limit the scope of the present disclosure.

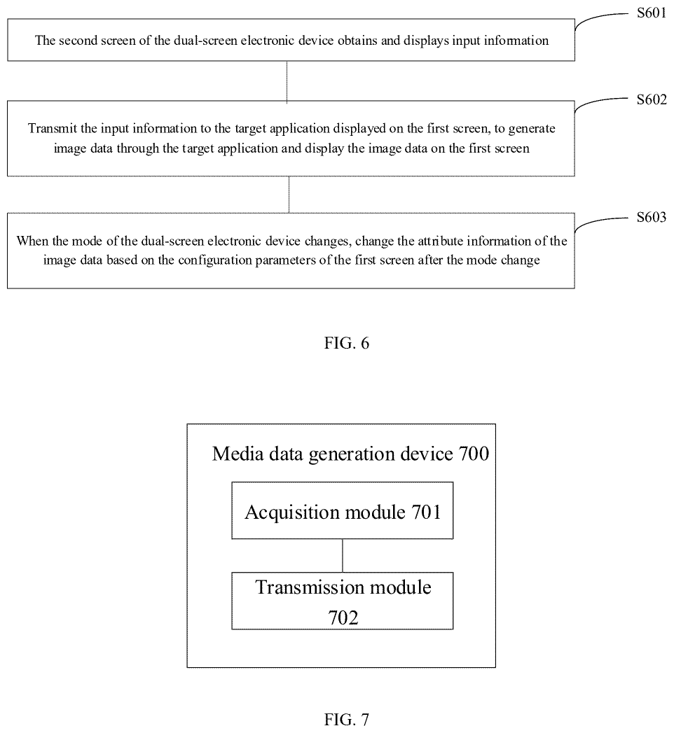

The present disclosure also provides a media data generation device. FIG. 7 is a

schematic diagram of a media data generation device provided by one embodiment of the present disclosure. As shown in FIG. 7, the media data generation device 700 includes an acquisition module 701 and a transmission module 702.

The acquisition module 701 may be configured to: respond to the first electronic device obtaining input information through an input module, and not display the input information on the first screen.

The transmission module 702 may be configured to transmit the input information to the target application running on the first screen, to generate target media data through the target application. The target media data may be at least partially different from the content of the input information, and the first screen and/or the input module may belong to or not belong to the first electronic device.

In some embodiments, the acquisition module 701 may be also used to: obtain the input information through the second screen of the first electronic device or the second electronic device; obtain the input information through the sensor of the first electronic device or the second electronic device; or, obtain the input information through the input component of the first electronic device or the second electronic device. The second electronic device may be a device that establishes a target communication connection with the first electronic device.

In some embodiments, the transmission module 702 may be further used to: when the input information is obtained through the sensor of the first electronic device, convert the input information into reference data for the target application to generate the media data, and transmit the converted reference data to the target application running on the first screen; when the input information is obtained through the first application displayed on the second screen of the first electronic device, the first electronic device transmits the input information obtained in the first application to the target application running on the first screen by calling the interface of the target application.

In some embodiments, the transmission module 702 may be further used to: perform semantic analysis on the input information through the target application, and use the obtained semantic analysis result as the reference data to generate the target media data; perform sentiment analysis on the input information through the target application, and use the obtained sentiment analysis result as the reference data to generate the target media data; based on the display parameters of the input information, use the display parameters as the reference data to generate the target media data; or, based on the audio parameters of the input information, use the audio parameters as the reference data to generate the target media data.

In some embodiments, the transmission module 702 may be also used to: when the input information includes text content, perform semantic analysis and/or sentiment analysis on the text content, and use at least one of the semantic theme features, content categories, and sentiment features obtained by the analysis as the reference data to generate the target media data; when the input information includes audio content, perform semantic analysis and/or sentiment analysis on the audio content, and use at least one of the semantic theme features, sentiment features, and audio parameters obtained by the analysis as the reference data to generate the target media data; when the input information includes the display parameters of the input content, use at least one of the color, transparency, and hue of the display parameters as the reference data to generate the target media data; or, when the input information includes audio parameters of the input speech, use at least one of the frequency, timbre, and channel of the audio parameters as the reference data to generate the target media data.

In some embodiments, the transmission module 702 may also be used to: in

response to the input information being in an inputting state, transmit the obtained input information to the target application at a preset time interval; in response to the input information switching from the inputting state to the input completion state, transmit the obtained input information in the input completion state to the target application; in response to a target operation on the input information, transmit the input information selected by the target operation to the target application; in response to a morphological change of the first electronic device, transmit the input information obtained by the unit electronic device before the morphological change to the target application; or, in response to the first electronic device establishing a communication connection with a terminal device, transmit the input information obtained in the first electronic device to the target application.

In some embodiments, the input module may include a second screen, and the transmission module 702 may be further used to: in response to the selection operation of the target media data displayed on the first screen, distinctively display the input information corresponding to the selected target media data on the second screen, and/or, based on the selected target media data, regenerate the target media data with the selected target media data as the reference data on the first screen; in response to the selection operation of the input information displayed on the second screen, distinctively display the target media data corresponding to the selected input information on the first screen, and/or, regenerate the target media data corresponding to the selected input information on the first screen.

In some embodiments, the media data generation device 700 may further include a determination module 703, which is used to determine the target output module for outputting the target media data based on the type and/or amount of the target media data, and output the target media data through the corresponding target output module. The target output module may include at least one of a display output module or an audio output module.

In some embodiments, the determination module 703 may be further used to: when the target media data includes image data, output the image data through the display output module, where the display output module is a first screen; when the target media data includes multiple image data, output each of the multiple image data in sequence through the display output module at a preset time interval, where the display output module is a first screen; when the target media data includes audio data, output the audio data through one or more audio output modules, where the audio output modules include an audio output module of the first electronic device; when the target media data includes audio data, output the audio data through one or more audio output modules, and use the audio data as the reference data to generate image data which is output through the display output module, where the audio output modules include the audio output module of the first electronic device, and the display output module is the first screen; when the target media data includes image data and audio data, output the audio data through one or more audio output modules, and output the image data through the display output module, where the audio output modules include the audio output module of the first electronic device, and the display output module is the first screen; when the target media data includes image data, convert the image data into audio data describing the image data, and output the audio data through the audio output module, where the audio output module is the audio output module of the first electronic device and the display output module is the first screen.

The description of the above device embodiments is similar to the description of the above method embodiments, and has similar beneficial effects as the method embodiments. For technical details not disclosed in the device embodiments of the present disclosure, references may be made to the description of the method embodiments of the present disclosure for understanding.

In some embodiments, the above method may be implemented in the form of a software function module and sold or used as an independent product. Therefore, it may be stored in a computer-readable storage medium. Based on this understanding, the technical solution of the embodiments of the present disclosure or the part that contributes to the relevant technology may be embodied in the form of a software product, which is stored in a storage medium and includes several instructions to enable an electronic device (which can be a personal computer, a server, or a network device, etc.) to execute all or part of the methods described in each embodiment of the present disclosure. The aforementioned storage medium may include various media that can store program codes, such as a flash disk, a mobile hard disk, a read-only memory (ROM), a disk or an optical disk. In this way, the embodiments of the present disclosure are not limited to any specific combination of hardware and software.

The present disclosure also provides an electronic device, including a memory and a processor. The memory may be configured to store a computer program that is able to be executed on the processor, and the processor may implement the above method when executing the computer program. The electronic device provided in this embodiment may be the first electronic device in the method provided by the present disclosure.

The present disclosure also provides a computer-readable storage medium, on which a computer program is stored. The computer program may implement the above method when executed by a processor. The computer-readable storage medium may be transient or non-transient.

The present disclosure also provides a computer program product, which includes a non-transitory computer-readable storage medium storing a computer program, and when the computer program is read and executed by a computer, some or all of the steps in the above method are implemented. The computer program product may be implemented in hardware, software or a combination thereof. In an optional embodiment, the computer program product may be specifically embodied as a computer storage medium. In another optional embodiment, the computer program product may be specifically embodied as a software product, such as a software development kit (SDK), etc.

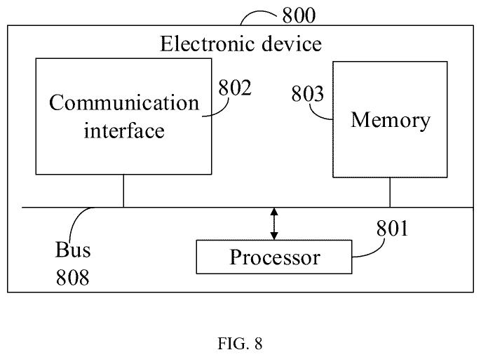

FIG. 8 is a schematic diagram of a hardware entity of an electronic device provided in an embodiment of the present disclosure. As shown in FIG. 8, the hardware entity of the electronic device 800 includes: a processor 801, a communication interface 802 and a memory 803.

The processor 801 may be configured to generally control the overall operation of the electronic device 800.

The communication interface 802 may be configured to enable the electronic device to communicate with other terminals or servers through a network.

The memory 803 may be configured to store instructions and applications executable by the processor 801, and may also be configured to store cache data to be processed or processed by the processor 801 and each module in the electronic device 800 (for example, image data, audio data, voice communication data and video communication data). The memory may be implemented by flash memory (FLASH) or random access memory (Random Access Memory, RAM). Data may be transmitted between the processor 801, the communication interface 802 and the memory 803 through the bus 804.

The description of the above storage medium and device embodiments is similar to the description of the above method embodiments and has similar beneficial effects as the method embodiments. For technical details not disclosed in the storage medium and device embodiments of the present disclosure, references may be made to the description of the method embodiments of the present disclosure for understanding.

“One embodiment” or “an embodiment” mentioned throughout the specification means that the specific features, structures or characteristics related to the embodiment are included in at least one embodiment of the present disclosure. Therefore, “in one embodiment” or “in an embodiment” appearing throughout the specification does not necessarily refer to the same embodiment. In addition, these specific features, structures or characteristics can be combined in one or more embodiments in any suitable manner.

In various embodiments of the present disclosure, the size of the serial number of each step/process mentioned above does not mean the order of execution. The execution order of each step/process should be determined by its function and internal logic, and should not constitute any limitation on the implementation process of the embodiments of the present disclosure. The serial number of one embodiment of the present disclosure is only for description and does not represent the advantages and disadvantages of the embodiment.

In the present disclosure, the terms such as “include,” “comprise” or any other variant thereof are intended to cover non-exclusive inclusion, such that a process, method, article or device including a series of elements includes not only those elements, but also includes other elements not explicitly listed, or also includes elements inherent to such process, method, article or device. In the absence of further restrictions, an element defined by the sentence “including a . . . ” does not exclude the existence of other identical elements in the process, method, article or device including the element.

In the embodiments provided in this disclosure, the disclosed devices and methods may be implemented in other ways. The device embodiments described above are only schematic. For example, the division of the units is only a logical function division. There may be other division methods in actual implementation. For example, multiple units or components can be combined, or can be integrated into another system, or some features can be ignored or not executed. In addition, the coupling, direct coupling, or communication connection between the components shown or discussed can be through some interfaces, and the indirect coupling or communication connection of the device or unit can be electrical, mechanical or other forms.

The units described above as separate components may or may not be physically separated, and the components shown as units may or may not be physical units. They may be located in one place or distributed on multiple network units. Some or all of the units may be selected according to actual needs to achieve the purpose of the scheme of the present disclosure.

In addition, all functional units in the embodiments of the present disclosure may be integrated into one processing unit, or each unit may be used as a separate unit, or two or more units may be integrated into one unit. The above integrated unit may be implemented in the form of hardware or in the form of hardware plus software functional units.

Those skilled in the art can understand that all or part of the steps of implementing the above method embodiments may be completed by hardware related to program instructions, and the above program may be stored in a computer-readable storage medium. When the program is executed, the steps of the above method embodiments may be executed. The above storage medium may include: a mobile storage device, a read-only memory, a disk or an optical disk, etc., which can store program codes.

Alternatively, when the above integrated unit of the present disclosure is implemented in the form of a software functional module and sold or used as an independent product, it may also be stored in a computer-readable storage medium. Based on this understanding, the technical solution of the present disclosure may be essentially or partly embodied in the form of a software product that contributes to the relevant technology. The computer software product may be stored in a storage medium and include several instructions to enable a computer device (which can be a personal computer, a server, or a network device, etc.) to execute all or part of the methods described in the various embodiments of the present disclosure. The aforementioned storage media may include: mobile storage devices, ROM, magnetic disks, optical disks, and other media that can store program codes.

Various embodiments have been described to illustrate the operation principles and exemplary implementations. Those skilled in the art would understand that the present disclosure is not limited to the specific embodiments described herein and there can be various other changes, rearrangements, and substitutions. Thus, while the present disclosure has been described in detail with reference to the above described embodiments, the present disclosure is not limited to the above described embodiments, but may be embodied in other equivalent forms without departing from the spirit and scope of the present disclosure.

What is claimed is:

1. A media data generation method comprising:
obtaining, by an electronic device through an input module, input information, the input information not being displayed on a screen; and
transmitting the input information to a target application running on the screen to generate target media data through the target application, the target media data being at least partially different from content of the input information.

2. The method according to claim 1, wherein the electronic device includes at least one of the screen or the input module.

3. The method according to claim 1, wherein at least one of the screen or the input module is not a component of the electronic device.

4. The method according to claim 1, wherein:
the electronic device is a first electronic device and the screen is a first screen; and
obtaining the input information includes at least one of:
obtaining the input information through a second screen, the first electronic device or a second electronic device including the second screen, and a target communication connection being established between the first electronic device and the second electronic device;
obtaining the input information through a sensor, the first electronic device or the second electronic device including the sensor; or
obtaining the input information through an input component, the first electronic device or the second electronic device including the input component.

5. The method according to claim 4, wherein:
the first electronic device includes the sensor and the input information is obtained through the sensor; and
transmitting the input information to the target application includes:
converting the input information into reference data; and
transmitting the reference data to the target application for the target application to generate the target media data based on the reference data.

6. The method according to claim 4, wherein:
the first electronic device includes the second screen and the input information is obtained through an application running on the second screen; and
transmitting the input information to the target application includes:
transmitting the input information to the target application through a target interface between the target application and the application running on the second screen.

7. The method according to claim 1, wherein transmitting the input information to the target application to generate the target media data through the target application includes at least one of:
performing semantic analysis on the input information through the target application to obtain a semantic analysis result, and generating the target media data using the semantic analysis result as reference data;
performing sentiment analysis on the input information through the target application to obtain a sentiment analysis result, and generating the target media data using the sentiment analysis result as reference data;
generating the target media data using a display parameter of the input information as reference data; or
generating the target media data using an audio parameter of the input information as reference data to generate the target media data.

8. The method according to claim 7, wherein:
the input information includes text content; and
transmitting the input information to the target application to generate the target media data through the target application includes:
performing at least one of the semantic analysis or the sentiment analysis on the text content to obtain one or more of a semantic theme feature, a content category, and a sentiment feature, and generating the target media data using at least one of the one or more of the semantic theme feature, the content category, or the sentiment feature as reference data.

9. The method according to claim 7, wherein:
the input information includes audio content; and
transmitting the input information to the target application to generate the target media data through the target application includes:
performing at least one of the semantic analysis or the sentiment analysis on the audio content to obtain one or more of a semantic theme feature, a sentiment feature, and the audio parameter, and generating the target media data using at least one of the one or more of the semantic theme feature, the sentiment feature, and the audio parameter as reference data.

10. The method according to claim 7, wherein:
the input information includes a display parameter of input content that includes at least one of color, transparency, or hue; and
transmitting the input information to the target application to generate the target media data through the target application includes:
generating the target media data using the at least one of the color, the transparency, or the hue as reference data.

11. The method according to claim 7, wherein:
the input information includes an audio parameter of an input speech, the audio parameter including at least one of frequency, timbre, or channel; and
transmitting the input information to the target application to generate the target media data through the target application includes:
generating the target media data using the at least one of the frequency, the timbre, or the channel as reference data.

12. The method according to claim 1, wherein:
the electronic device is a first electronic device; and
transmitting the input information to the target application includes at least one of:
in response to the input information being in an inputting state, transmitting the input information that is obtained to the target application at a preset time interval;
in response to the input information switching from an inputting state to an input completion state, transmitting the input information in the input completion state to the target application;
in response to a target operation on the input information, transmitting the input information selected by the target operation to the target application;
in response to a change in a form of the first electronic device, transmitting the input information obtained by the first electronic device before the form is changed to the target application; or
in response to the first electronic device establishing a communication connection with a second electronic device, transmitting the input information obtained by the first electronic device to the target application.

13. The method according to claim 1,
wherein the screen is a first screen and the input module includes a second screen;
the method further comprising at least one of:
in response to a selection operation on the target media data displayed on the first screen, distinctively display the input information corresponding to the selected media data on the second screen, and/or regenreating the target media data on the first screen based on the selected media data; or
in response to a selection operation on the input information displayed on the second screen, displaying media data corresponding to the selected input information on the first screen, and/or regenerating the target media data corresponding to the selected input information on the first screen.

14. The method according to claim 1, further comprising:
determining a target output module based on at least one of a type or an amount of the target media data and outputting the target media data through the target output module, the target output module including at least one of a display output module or an audio output module.

15. The method according to claim 14, wherein:
the electronic device is a first electronic device and the screen is a first screen; and
determining the target output module based on the at least one of the type or the amount of the target media data and outputting the target media data through the target output module include:
in response to the target media data including an image, outputting the image to the first screen or to a second screen or a third screen, a second electronic device including the second screen or the third screen;
in response to the target media data including a plurality of images, sequentially outputting, at a preset time interval, the plurality of images to the first screen or to the second screen or the third screen;
in response to the target media data including audio data, outputting the audio data through at least one of an audio output module of the first electronic device or an audio output module of the second electronic device;
in response to the target media data including audio data:
outputting the audio data through at least one of the audio output module of the first electronic device or the audio output module of the second electronic device; and
outputting image data generated based on the audio data through at least one of a display screen of the first electronic device or a display screen of the second electronic device;
in response to the target media data including image data and audio data:
outputting the audio data through at least one of the audio output module of the first electronic device or the audio output module of the second electronic device; and
outputting the image data through at least one of the display screen of the first electronic device or the display screen of the second electronic device; or
in response to the target media data including image data, converting the image data into audio data describing the image data and outputting the audio data describing the image data through at least one of the audio output module of the first electronic device or the audio output module of the second electronic device.

16. An electronic device comprising:
a memory storing a computer program; and
a processor configured to execute the computer program to:
obtain, through an input module, input information, the input information not being displayed on a screen; and
transmit the input information to a target application running on the screen to generate target media data through the target application, the target media data being at least partially different from content of the input information.

17. An electronic device comprising:
a first screen;
a second screen;
a memory storing a computer program; and
a processor configured to execute the computer program to:
obtain, through an input module, input information, the input information not being displayed on the first screen; and
transmit the input information to a target application running on the first screen to generate target media data through the target application, the target media data being at least partially different from content of the input information.

18. The electronic device according to claim 17, wherein the electronic device further includes the input module.

19. The electronic device according to claim 17, wherein the electronic device does not include the input module.

20. The electronic device according to claim 17, wherein the processor is configured to execute the computer program to, when transmitting the input information to the target application to generate the target media data through the target application, perform at least one of:
performing semantic analysis on the input information through the target application to obtain a semantic analysis result, and generating the target media data using the semantic analysis result as reference data;
performing sentiment analysis on the input information through the target application to obtain a sentiment analysis result, and generating the target media data using the sentiment analysis result as reference data;
generating the target media data using a display parameter of the input information as reference data; or
generating the target media data using an audio parameter of the input information as reference data to generate the target media data.
